(19) United States
(12) Patent Application Publication
(10) Pub. No.: US 2026/0242705 A1
(43) Pub. Date: Aug. 20, 2026

(54) VACUUM SEALING COMPONENT

(71) Applicant: Donnguan Holluck Electrical Technology Co., Ltd., Dongguan (CN)

(72) Inventor: Peiheng Huang, Shanwei (CN)

(21) Appl. No.: 19/644,554

(22) Filed: Apr. 10, 2026

(30) Foreign Application Priority Data
Oct. 28, 2025 (CN) 202522288188.0
Oct. 28, 2025 (CN) 202620176881.0

(51) Int. Cl. C12H 1/16

(52) U.S. Cl. CPC C12H 1/16

(57) ABSTRACT

Provided is a vacuum sealing component, which includes a sealing plug and an upper cover arranged at an upper end of the sealing plug. The upper cover and the sealing plug are provided with an installation cavity, a first through hole communicated to the installation cavity is provided in the upper cover. A second through hole communicated to the installation cavity is provided in the sealing plug, and an elastic sealing plug configured to control opening or closing of the first through hole is provided in the installation cavity. A top of the upper cover is provided with an insertion slot, and an upper end of the elastic sealing plug can pass through the first through hole and extend into the insertion slot. The vacuum sealing component in the present disclosure is separated from a wine dispenser main body.

### CROSS-REFERENCE TO RELATED APPLICATIONS

This application claims priority to Chinese Patent Application No. 202522288188.0, filed on Oct. 28, 2025 and Chinese Patent Application No. 202620176881.0, filed on Oct. 28, 2025. Both of which are hereby incorporated by reference in their entireties.

### TECHNICAL FIELD

The present disclosure relates to the field of electric wine dispenser technologies, and in particular, to a multifunctional wine dispenser.

### BACKGROUND

With an improvement in living standards, red wine has evolved from a niche beverage to a common choice on dining tables today. However, newly opened red wine contains a large number of tannins, which can make people feel that the wine is very astringent. In a natural state and in contact with air, it takes forty minutes to an hour for the tannins to fully soften and eliminate the astringent feeling. Moreover, when red wine cannot be consumed in one go after opening, it needs to be stored. The traditional method is to seal it directly with a red wine stopper, which cannot extract the air from the bottle and may cause the remaining red wine to spoil easily.

For this reason, in recent years, electric wine dispensers have emerged in the market that can quickly decant red wine and vacuum preserve remaining red wine. For example, CN110257211A discloses a red wine preservation device and a wine decanter using the device. When preservation is needed, a bottle mouth of the red wine bottle is first sealed with a rubber stopper to prevent air from entering the red wine bottle cavity and contact with the red wine. Then, the air brought in during the sealing of the red wine bottle cavity is pumped out by an air pump to create a certain degree of vacuum in the red wine bottle cavity, thereby achieving the function of red wine preservation. When drinking alcohol is needed, the solenoid valve opens to connect the red wine bottle cavity with the atmosphere. The air pump and water pump work simultaneously, driven by the water pump. The red wine first passes through the water pump and is finally discharged from a first three-way pipe fitting. Due to the connection between the air outlet of the air pump and one interface of the first three-way pipe fitting, and the connection between the discharge outlet of the water pump and another interface of the first three-way pipe fitting, and the simultaneous operation of the air pump and water pump, the red wine and air mix at the first three-way pipe fitting, achieving the function of sobering up.

However, the decanter using the red wine preservation device mentioned above needs to leave the entire decanter in the mouth of the red wine bottle when preserving the red wine. If multiple red wine bottles need to be preserved, it is necessary to prepare a set of decanters for each bottle, which will increase the cost of use for consumers, and when multiple sets of decanters are not in use, it will also cause inconvenience in storage and save.

Besides that, in order to prevent the liquid outlet of the electric wine dispenser from being exposed and breeding bacteria, as well as to prevent the bottle with the electric wine dispenser from being accidentally touched by external forces during movement or other operations, existing electric wine dispensers will be provided with mechanical touch panels for sealing the liquid outlet. CN217161777U discloses an anti-misoperation sealed electric liquid extractor, which is provided with a micro switch and a mechanical touch panel at the water outlet. The mechanical touch panel is provided with a touch panel at one end close to the micro switch, and one end away from the micro switch extends outward to below the water outlet, and can cover the water outlet. The mechanical touch panel can rotate along the axis. When the mechanical touch panel rotates to the lower limit position, the touch panel can trigger the micro switch, thereby enabling the water pump to work.

However, in the above-mentioned electric vacuum pump, the mechanical touch panel needs to collide with the micro switch to make the water pump work. Long term collision can easily cause wear and tear on internal parts or mechanical touch panels, thereby affecting the product's service life.

Therefore, it is necessary to provide a technical solution to solve the above-mentioned technical problems.

### SUMMARY

The purpose of the present disclosure is to provide a multifunctional wine dispenser to solve the above-mentioned technical problems.

In order to achieve the above objectives, the present disclosure adopts the following technical solution.

A multifunctional wine dispenser, including a wine dispenser main body, where the wine dispenser main body includes a housing and an electronic control component provided inside the housing; the electronic control component includes a main control circuit board, a power supply, a water pump, and an air pump, all of the main control circuit board, the power supply, the water pump, and the air pump are electrically connected to the main control circuit board; a lower end of the housing is provided with a plug-in bottle stopper, and the plug-in bottle stopper is provided with a gas connection pipe and a liquid connection pipe. An upper end of the housing is provided with a liquid outlet pipe. The multifunctional wine dispenser further includes a vacuum sealing component, and the vacuum sealing component is detachably connected to the plug-in bottle stopper. When the plug-in bottle stopper is not connected to the vacuum sealing component, the multifunctional wine dispenser can perform separate wine dispensing mode, wine decanting mode, or cleaning mode. When the plug-in bottle stopper is connected to the vacuum sealing component, the multifunctional wine dispenser can execute a vacuum mode.

In some embodiments of the present disclosure, the multifunctional wine dispenser further includes a pressure detector, and the pressure detector is electrically connected to the main control circuit board; a liquid inlet end of the water pump is connected to the liquid connection pipe through an liquid inlet pipe, and a liquid outlet end of the water pump is connected to a liquid outlet nozzle through the liquid outlet pipe; the gas connection pipe is connected to an air inlet end of the air pump and the pressure detector through a first three-way pipe; an air outlet end of the air pump is connected to the liquid outlet pipe through a second three-way pipe.

In some embodiments of the present disclosure, the vacuum sealing component includes a sealing plug and an upper cover arranged at an upper end of the sealing plug. The upper cover and the sealing plug are provided with an installation cavity, and a first through hole communicated to the installation cavity is provided in the upper cover. A second through hole communicated to the installation cavity is provided in the sealing plug, and an elastic sealing plug configured to control opening or closing of the first through hole is provided in the installation cavity; a top of the upper cover is provided with an insertion slot, and an upper end of the elastic sealing plug can pass through the first through hole and extend into the insertion slot. The plug-in bottle stopper can be inserted into the insertion slot.

In some embodiments of the present disclosure, a sealing gasket is provided at one end of the installation cavity near the first through hole, and the sealing gasket extends into the first through hole. A third through hole communicated to the installation cavity is provided at a portion of the sealing gasket that is in the first through hole. The elastic sealing plug is configured to control opening or closing of the third through hole.

In some embodiments of the present disclosure, the elastic sealing plug includes a sealing plug and an elastic member arranged between the sealing plug and a bottom of the installation cavity. The sealing plug includes a plug body and a conical plug arranged at an upper end of the plug body. One end of the third through hole away from the first through hole is also arranged in a conical shape.

In some embodiments of the present disclosure, the vacuum sealing component further includes a rotating ring, where the sealing plug and the upper cover are both provided in the rotating ring. The rotating ring can rotate relative to the upper cover, and there are a plurality of markings and Arabic numerals along a circumferential direction on the rotating ring. The upper cover is provided with an indicator triangle configured to point to the markings or Arabic numerals.

In some embodiments of the present disclosure, the housing is further provided with a control switch and a movable cover plate. The control switch is electrically connected to the main control circuit board, and the movable cover plate can move between a first position and a second position under external force. When the movable cover plate is in the first position, the movable cover covers the liquid outlet nozzle, and the multifunctional wine dispenser is in a power-off and shutdown state. When the movable cover plate is in the second position, the control switch is triggered and sends a signal to the main control circuit board, and the main control circuit board controls the water pump and/or the air pump to operate.

In some embodiments of the present disclosure, the control switch is a Hall switch, and an installation end of the movable cover plate is rotatably connected to the housing through a rotating shaft. One side of a free end of the movable cover plate is provided with a sealing recess, and the other side is provided with a first induction magnet. When the movable cover plate is in the first position, the sealing recess covers the liquid outlet nozzle, and the multifunctional wine dispenser is in the power-off and shutdown state. When the movable cover plate is in the second position, the first induction magnet triggers the Hall switch, and the Hall switch sends a signal to the main control circuit board, and the main control circuit board controls the water pump and/or the air pump to operate.

In some embodiments of the present disclosure, the installation end of the movable cover plate is provided with a second induction magnet, and the second induction magnet is provided at one end of the installation end. The main control circuit board is provided with a magnetic trigger switch. During the movement of the movable cover plate from the first position to the second position, the second induction magnet gradually approaches the magnetic trigger switch. When the second induction magnet reaches a trigger position, the magnetic trigger switch is triggered by the second induction magnet and sends a signal to the main control circuit board. The wine dispenser main body is powered on and standby, and at this time, the movable cover plate is located between the first position and the second position.

In some embodiments of the present disclosure, a top of the housing is provided with a main control panel, and the main control panel is electrically connected to the main control circuit board. The main control panel is provided with a display screen and a plurality of control buttons; the plurality of control buttons include a mode switching button, a liquid output increase adjustment button and a liquid output reduce adjustment button.

The beneficial effects of the present disclosure are as follows.
(1) By providing the vacuum sealing component and separating the vacuum sealing component from the wine dispenser main body, consumers can determine whether to connect the vacuum sealing component to the wine dispenser main body according to their actual usage needs, rendering it convenient and flexible to use; and because when sealing the wine bottle, only the vacuum sealing component needs to be left on the bottle, and the wine dispenser main body can be separated for continued use, consumers only need to prepare one wine dispenser main body and multiple vacuum sealing components to achieve vacuum sealing of multiple wine bottles, effectively reducing the cost of use. Besides that, the volume of the vacuum sealing component is much smaller than that of the wine dispenser main body, so it will not cause inconvenience in storage and save.
(2) The vacuum sealing component is provided with the elastic sealing plug for controlling the opening or closing of the vacuum sealing component. When there is no external force, the elastic sealing plug closes the vacuum sealing component under the action of elasticity. When the vacuum sealing component is connected to the plug bottle, the gas pipe squeezes the elastic sealing plug to overcome the elasticity and move, which can open the vacuum sealing component without the need for electronic components such as solenoid valves for control. This is conducive to simplifying the overall structure of the multifunctional wine dispenser, reducing the failure rate, and improving reliability.
(3) By sensing the first induction magnet and the Hall switch, the multifunctional wine dispenser can be controlled to start working. There is no need for collision between the first induction magnet and the Hall switch, thereby avoiding wear and tear problems and extending the product's service life to a limited extent.

### BRIEF DESCRIPTION OF DRAWINGS

FIG. 1 is a schematic structural diagram of a multifunctional wine dispenser of the present disclosure without installing a vacuum sealing component.

FIG. 2 is a schematic structural diagram of the multifunctional wine dispenser of the present disclosure when installing the vacuum sealing component.

FIG. 3 is a partially decomposed schematic diagram of the multifunctional wine dispenser of the present disclosure.

FIG. 4 is a schematic diagram of a partial structure of the multifunctional wine dispenser of the present disclosure.

FIG. 5 is a schematic structural diagram of the vacuum sealing component of the present disclosure.

FIG. 6 is an exploded schematic diagram of the vacuum sealing component of the present disclosure.

FIG. 7A is a schematic diagram of the multifunctional wine dispenser executing separate wine dispensing mode, and FIG. 7B is a schematic diagram of the multifunctional wine dispenser executing a wine dispensing and sobering mode; arrows [symbol] in the figure indicate a movement direction of liquid, and the arrows ⬆ indicate a movement direction of gas.

FIG. 8A is a schematic diagram of the multifunctional wine dispenser in vacuum mode, and FIG. 8B is a schematic diagram of the vacuum sealing component sealing a bottle mouth; arrows [symbol] in the figure indicate the movement direction of liquid, and the arrows ⬆ indicate the movement direction of gas.

FIG. 9 is an enlarged schematic structural diagram of point A in FIG. 8A.

Numeral reference: 10—wine dispenser main body; 1—housing; 11—water outlet section; 12—straight tube section; 21—main control circuit board; 23—water pump; 24—air pump; 25—pressure detector; 27—magnetic trigger switch; 28—charging interface; 31—liquid connection pipe; 32—liquid inlet pipe; 33—liquid outlet pipe; 34—gas connection pipe; 35—first three way tube; 36—second three way tube; 37—extraction tube; 4—plug-in bottle stopper; 5—liquid outlet nozzle; 61—movable cover plate; 62—rotating shaft; 63—sealing recess; 64—first induction magnet; 65—second induction magnet; 7—main control panel; 71—display screen; 72—mode switching button; 73—liquid output increase adjustment button; 74—liquid output reduce adjustment button; 75—start button; 8—vacuum sealing component; 81—elastic sealing plug; 811—sealing plug; 8111—plug body; 8112—conical plug; 8113—lower needle-shaped rod; 8114—upper needle-shaped rod; 812—elastic member; 82—sealing plug; 821—installation bracket; 822—cock body; 83—upper cover; 831—insertion slot; 832—indicator triangle; 84—installation cavity; 85—first through hole; 86—second through hole; 87—sealing gasket; 88—third through hole; 89—rotating ring; 891—marking; 892—Arabic numeral; 9—wine bottle.

### DESCRIPTION OF EMBODIMENTS

In order to facilitate the understanding of those skilled in the art, further explanation of the present disclosure is provided below in combination with the embodiments and accompanying drawings. The content mentioned in the embodiments is not a limitation of the present disclosure.

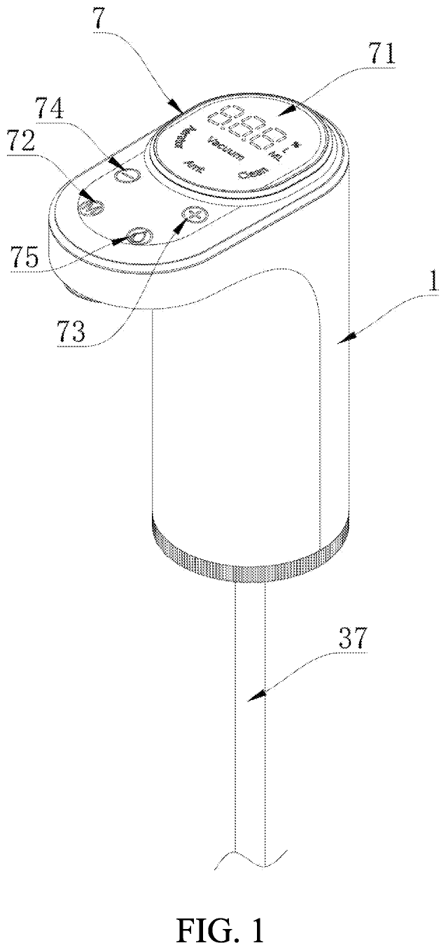

As shown in FIGS. 1-6, this embodiment provides a multifunctional wine dispenser, which includes a wine dispenser main body 10. The wine dispenser main body 10 includes a housing 1 and an electronic control component arranged inside the housing 1. The electronic control component includes a main control circuit board 21, a power supply, a water pump 23, and an air pump 24, all of the main control circuit board 21, the power supply, the water pump 23, and the air pump 24 are electrically connected to the main control circuit board 21. In an implementation mode, the power source is a rechargeable battery, and the housing 1 is correspondingly provided with a charging interface 28, and the charging interface 28 is electrically connected to the main control circuit board 21. A lower end of the housing 1 is provided with a plug-in bottle stopper 4, and the plug-in bottle stopper 4 is provided with a gas connection pipe 34 and a liquid connection pipe 31. The liquid connection pipe 31 can be detachably connected to an extraction tube 37, and the extraction tube 37 is configured to insert into the liquid for the water pump to suction liquid. An upper end of the housing 1 is provided with a liquid outlet nozzle 5. In an implementation mode, a top of the housing 1 extends forward to form a water outlet section 11. The housing 1 is located below the water outlet section 11 and is provided with a straight tube section 12. The liquid outlet nozzle 5 is arranged on the water outlet section 11. The multifunctional wine dispenser further includes a vacuum sealing component 8, and the vacuum sealing component 8 is detachably connected to the plug-in bottle stopper 4. The vacuum sealing component 8 is provided with an elastic sealing plug 81 for controlling the opening or closing of the vacuum sealing component 8. When the plug-in bottle stopper 4 is not connected to the vacuum sealing component 8, the multifunctional wine dispenser can perform a separate wine dispensing mode, wine decanting mode, or cleaning mode. When the plug-in bottle stopper 4 is connected to the vacuum sealing component 8, the gas connection pipe 34 drives the elastic sealing plug 81 to open the vacuum sealing component 8. The multifunctional wine dispenser can execute a vacuum mode. After the vacuum mode is completed, the plug-in bottle stopper 4 separates from the vacuum sealing component 8, and the elastic sealing plug 81 closes the vacuum sealing component 8. The vacuum sealing component 8 remains at a bottle mouth of the wine bottle and seals the bottle mouth.

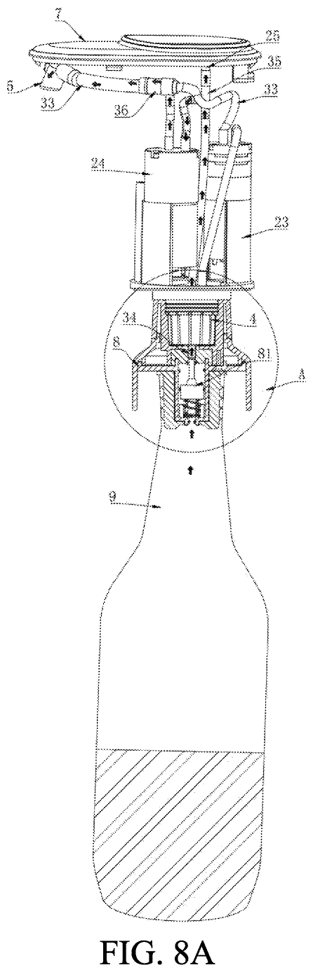

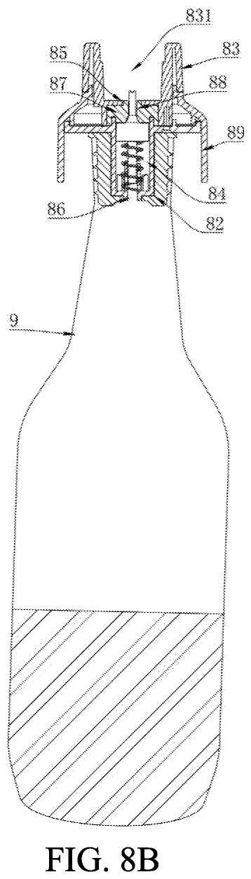

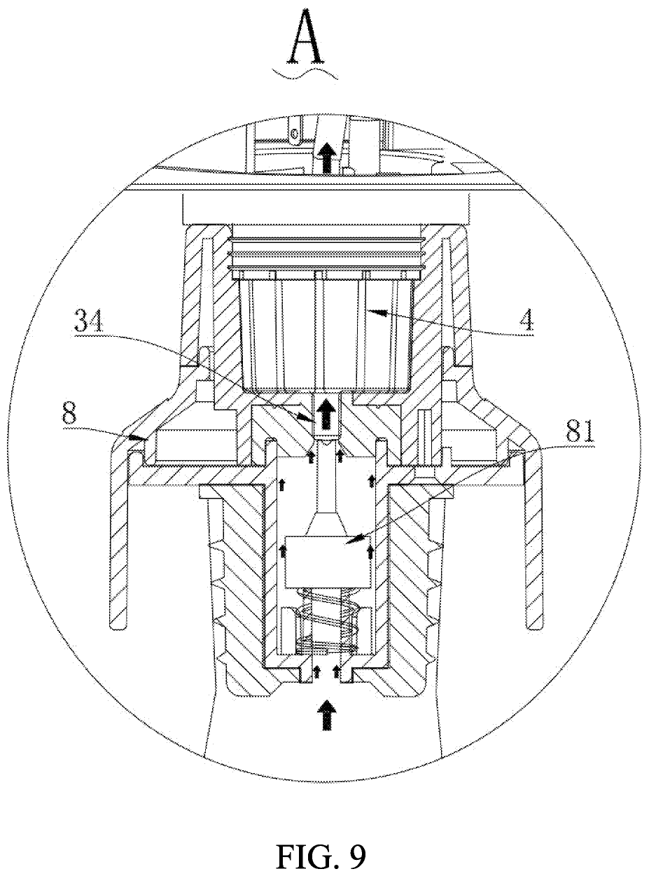

In this embodiment, by providing the vacuum sealing component 8 and separating it from the wine dispenser main body 10, consumers can determine whether to connect the vacuum sealing component 8 to the wine dispenser main body 10 according to their actual usage needs. When it is necessary to perform separate wine dispensing mode, wine decanting mode, or cleaning mode, there is no need to connect the vacuum sealing component 8 to the wine dispenser main body 10. When the vacuum mode needs to be executed, the vacuum sealing component 8 can be connected to the wine dispenser main body 10 to execute this mode, which is convenient and flexible to use. And because when sealing the wine bottle, only the vacuum sealing component 8 needs to be left on the wine bottle, as shown in FIG. 8B, the wine dispenser main body 10 can be separated and continued to be used. Therefore, consumers only need to prepare one wine dispenser main body 10 and multiple vacuum sealing components 8 to achieve vacuum sealing of multiple wine bottles, effectively reducing the cost of use. Moreover, the volume of the vacuum sealing component 8 is much smaller than that of the wine dispenser main body 10, so it will not cause inconvenience in storage and save. Furthermore, the vacuum sealing component 8 is provided with an elastic sealing plug 81 for controlling the opening or closing of the vacuum sealing component 8. When there is no external force, the elastic sealing plug 81 closes the vacuum sealing component 8 under the action of elasticity. When the vacuum sealing component 8 is connected to the bottle stopper 4, the gas connection pipe 34 presses the elastic sealing plug 81 to overcome the elasticity and move it, which can open the vacuum sealing component 8 without the need for electronic components such as solenoid valves for control. This is conducive to simplifying the overall structure of the multifunctional wine dispenser, reducing the failure rate, and improving reliability.

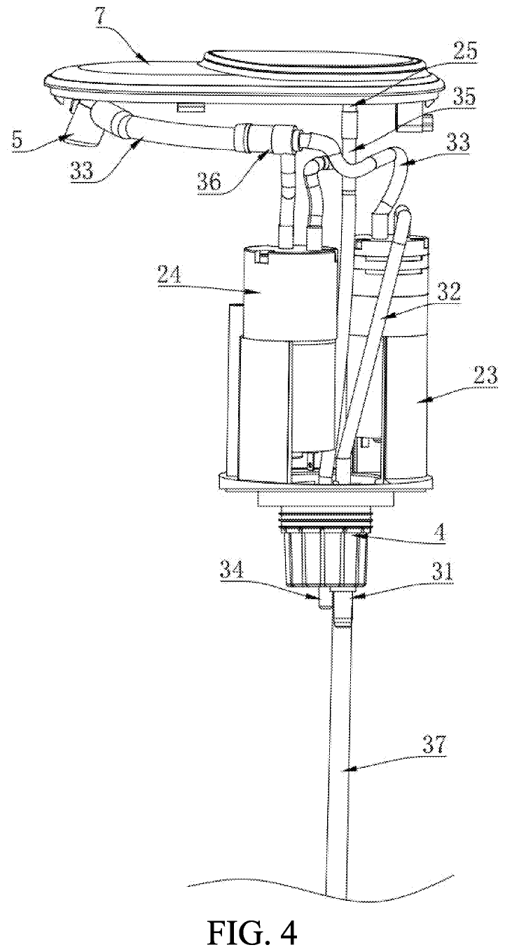

In an implementation mode, as shown in FIG. 4, the multifunctional wine dispenser further includes a pressure detector 25, and the pressure detector 25 is electrically connected to the main control circuit board 21. A liquid inlet end of the water pump 23 is connected to the liquid connection pipe 31 through the liquid inlet pipe 32, and a liquid outlet end of the water pump 23 is connected to the liquid outlet nozzle 5 through the liquid outlet pipe 33. The gas connection pipe 34 is respectively connected to an air inlet end of the air pump 24 and the pressure detector 25 through a first three-way pipe 35. An air outlet end of the air pump 24 is connected to the liquid outlet pipe 33 through a second three-way pipe 36. In this embodiment, the air pressure detector 25 is connected to the air inside the wine bottle 9 through the first three-way pipe 35 and the gas connection pipe 34. Therefore, during a vacuuming process, the air pressure detector 25 can detect pressure inside the wine bottle 9 in real time. On the one hand, a display screen 71 can be provided on the wine dispenser main body 10 to provide real-time feedback to the user on the pressure inside the bottle, rendering it easier for the user to stop the vacuuming process according to the pressure inside the bottle. On the other hand, a target air pressure value for the vacuum mode can also be preset. When a detection structure of the air pressure detector 25 reaches a preset target air pressure value, a signal is sent to the main control circuit board 21, and the main control circuit board 21controls the air pump 24 to stop working.

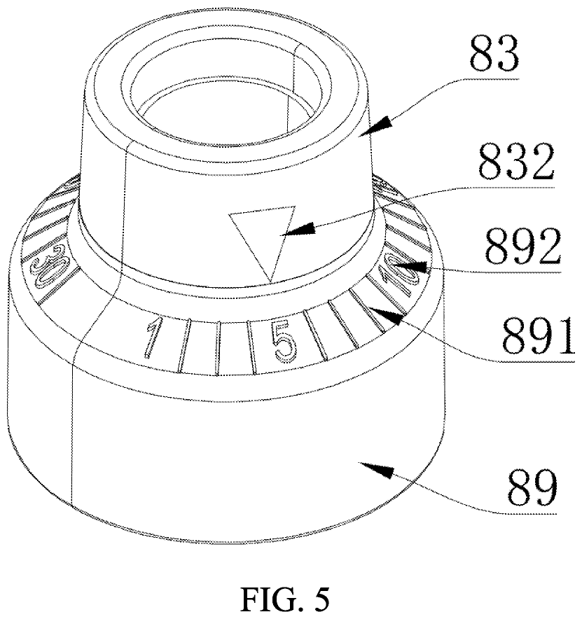

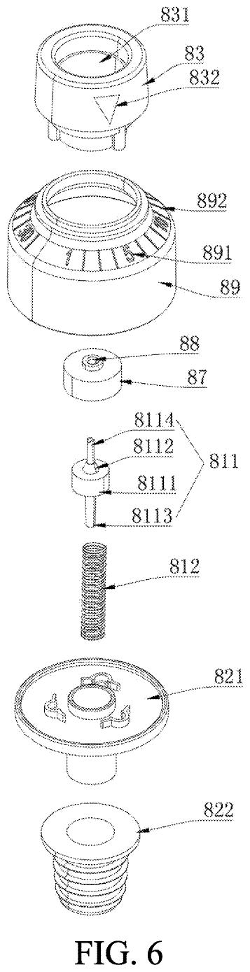

In an implementation mode, as shown in FIGS. 5-6, the vacuum sealing component 8 includes a sealing plug 82 and an upper cover 83 arranged at an upper end of the sealing plug 82. The upper cover 83 and the sealing plug 82 are provided with an installation cavity 84, and the elastic sealing plug 81 is arranged in the installation cavity 84. The upper cover 83 is provided with a first through hole 85 communicated to the installation cavity 84, and the sealing plug 82 is provided with a second through hole 86 communicated to the installation cavity 84. The elastic sealing plug 81 is configured to control the opening or closing of the first through hole 85. A top of the upper cover 83 is provided with an insertion slot 831, and an upper end of the elastic sealing plug 81 can pass through the first through hole 85 and extend into the insertion slot 831. The plug-in bottle stopper 4 can be inserted into the insertion slot 831. In an implementation mode, the sealing plug 82 includes an installation bracket 821 and a cock body 822 sleeved outside the installation bracket 821, and the installation cavity 84 is provided in the installation bracket 821. In this embodiment, an insertion slot 831 is provided to facilitate a detachable connection between the plug-in bottle stopper 4 and the vacuum sealing component 8; and when the elastic sealing plug 81 is not subjected to external force, its upper end extends through the first through hole 85 to the insertion slot 831 under the action of elastic force. At this time, the first through hole 85 is blocked, and the vacuum sealing component 8 is in a closed state. When the bottle stopper 4 is inserted into the insertion slot 831, the gas connection pipe 34 can precisely squeeze the upper end of the elastic sealing plug 81 to overcome the elastic force and move downwards. At this time, the first through hole 85 is opened, and the vacuum sealing component 8 is in an open state.

In an implementation mode, as shown in FIGS. 6 and 8, a sealing gasket 87 is provided at one end of the installation cavity 84 close to the first through hole 85. The sealing gasket 87 extends into the first through hole 85, and a portion of the sealing gasket 87 located in the first through hole 85 is provided with a third through hole 88 that is communicated to the installation cavity 84. The elastic sealing plug 81 is configured to control the opening or closing of the third through hole 88. The elastic sealing plug 81 includes a sealing plug 811 and an elastic member 812 arranged between the sealing plug 811 and a bottom of the installation cavity 84. The sealing plug 811 includes a plug body 8111 and a conical plug 8112 arranged at an upper end of the plug body 8111. One end of the third through hole 88 away from the first through hole 85 is also arranged in a conical shape. In an implementation mode, the elastic member 812 is a compression spring, and the sealing plug 811 further includes a lower needle shaped rod 8113 and an upper needle shaped rod 8114. The lower needle shaped rod 8113 is disposed at a lower end of the plug body 8111, and the upper needle shaped rod 8114 is disposed at an upper end of the conical plug 8112. The upper needle shaped rod 8114 can be inserted into the third through hole 88, and a diameter of the upper needle shaped rod 8114 is smaller than an aperture of the third through hole 88. The lower needle shaped rod 8113 can be inserted into the second through hole 86, and a diameter of the lower needle shaped rod 8113 is smaller than an aperture of the second through hole 86. By providing the upper needle shaped rod 8114 and the lower needle shaped rod 8113, it is helpful for sealing and guide a movement direction of sealing plug 811. When the elastic sealing plug 81 is not subjected to external force, the conical plug 8112 is abutted against a conical end of the third through hole 88 under an action of elastic force. At this time, the third through hole 88 is blocked, and the vacuum sealing component 8 is in a closed state. When the bottle stopper 4 is inserted into the insertion slot 831, the gas connection pipe 34 can just squeeze the upper needle-shaped rod 8114 to render the sealing plug 811 overcome the elastic force and move downwards. At this time, the conical plug 8112 leaves the conical end of the third through hole 88, and the third through hole 85 is opened, and the vacuum sealing component 8 is in an open state. Due to the elastic deformation of the sealing gasket 87 under external force, it can effectively fill small gaps on the sealing surface. In this embodiment, the sealing gasket 87 is arranged and the elastic sealing plug 81 controls the opening or closing of the vacuum sealing component 8 by controlling the third through hole 88 on the sealing gasket 87, thereby ensuring better sealing effect of the vacuum sealing component 8 when closed.

In an implementation mode, as shown in FIGS. 5 and 6, the vacuum sealing component 8 further includes a rotating ring 89, in which the sealing plug 82 and the upper cover 83 are provided. The rotating ring 89 can rotate relative to the upper cover 83, and there are a plurality of markings 891 and Arabic numerals 892 along a circumferential direction on the rotating ring 89. The upper cover 83 is provided with an indicator triangle 832 configured to point to the markings 891 or Arabic numerals 892. In an implementation mode, Arabic numerals 1, 5, 10, 15, 20, 25, and 30 are spaced along a circumference on the rotating ring, and 3 or 4 markings 891 are spaced between adjacent Arabic numerals 892. These markings 891 and Arabic numerals 892 correspond to date. In this embodiment, by providing the rotating ring 89, after vacuuming, the vacuum sealing component 8 is left at a bottle mouth position of the wine bottle 9 to seal the bottle mouth. At this time, the user can rotate the rotating ring 89 according to a sealing date, so that the marking 891 and Arabic numeral 892 on the rotating ring 89 are opposite to the indicator triangle 832. For example, when the sealed date is the 8th, rotate the rotating ring 89 to align the marking representing “8” with the indicator triangle 832. For example, when the sealed date is the 20th, rotate the rotating ring 89 to align the Arabic numeral “20” with the indicator triangle 832, rendering it easier for the user to understand the date of opening and sealing the bottle.

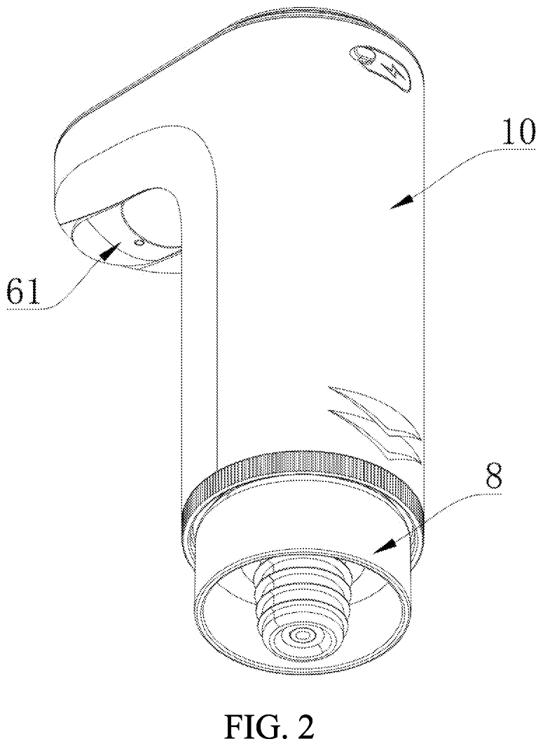

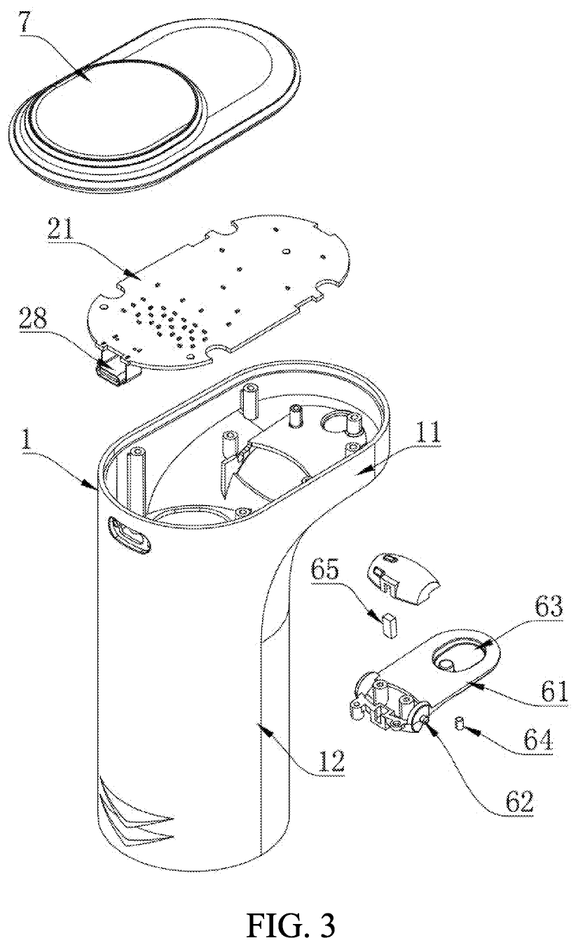

In an implementation mode, as shown in FIGS. 2-3, the housing 1 is further provided with a control switch (not shown in the figure) and a movable cover plate 61. The control switch is electrically connected to the main control circuit board 21, and the movable cover plate 61 can move between a first position and a second position under external force. When the movable cover plate 61 is in the first position, the movable cover plate 61 covers the liquid outlet nozzle 5, and the multifunctional wine dispenser is in a power-off and shutdown state. When the movable cover plate 61 is in the second position, the control switch is triggered and sends a signal to the main control circuit board 21, the main control circuit board 21 controls the water pump 23 and/or the air pump 24 to operate. In an implementation mode, the movable cover plate 61 is provided on the water outlet section 11, and the control switch is provided on the straight tube section 12.

In an implementation mode, as shown in FIG. 3, the control switch is a Hall switch, and an installation end of the movable cover plate 61 is rotatably connected to the water outlet section 11 of the housing 1 through a rotating shaft 62. One side of a free end of the movable cover plate 61 is provided with a sealing recess 63, and the other side is provided with a first induction magnet 64. When the movable cover plate 61 is in a first position, the sealing recess 63 covers the liquid outlet nozzle 5, and the multifunctional wine dispenser is in a power-off and shutdown state. When the movable cover plate 61 is in the second position, the first induction magnet 64 triggers the Hall switch, and the Hall switch sends a signal to the main control circuit board 21. The main control circuit board 21 controls the water pump 23 and/or the air pump 24 to operate. In this embodiment, the Hall switch is used as the control switch, and a first induction magnet 64 is synchronously provided on the movable cover plate 61. By the induction between the first induction magnet 64 and the Hall switch, the multifunctional wine dispenser can be controlled to start working. There is no need for collision between the first induction magnet 64 and the Hall switch, which avoids wear and tear problems and extends the service life of the product to a limited extent.

In an implementation mode, as shown in FIG. 3, the installation end of the movable cover plate 61 is provided with a second induction magnet 65, and the second induction magnet 65 is provided at one end of the installation end. The main control circuit board 21 is provided with a magnetic trigger switch 27. During the movement of the movable cover plate 61 from the first position to the second position, the second induction magnet 65 gradually approaches the magnetic trigger switch 27. When the second induction magnet 65 reaches the trigger position, the magnetic trigger switch 27 is triggered by the second induction magnet 65 and sends a signal to the main control circuit board 21. The wine dispenser main body 10 is powered on and standby. At this time, the movable cover plate 61 is located in the first position and between the second position. In this embodiment, a second induction magnet 65 is provided at the installation end of the movable cover plate 61 and a magnetic trigger switch 27 is provided on the main control circuit board 21. When the movable cover plate 61 moves from the first position to the second position, the second induction magnet 65 first reaches the trigger position and triggers the magnetic trigger switch 27, causing the multifunctional wine dispenser to be in a powered standby state, which facilitates the user to select the mode to be executed by the multifunctional wine dispenser in the standby state.

In an implementation mode, as shown in FIG. 1, the top of the housing 1 is provided with a main control panel 7, and the main control panel 7 is electrically connected to the main control circuit board 21. The main control panel 7 is provided with a display screen 71 and a plurality of control buttons; the plurality of the control buttons include a mode switching button 72, a liquid output increase adjustment button 73, and a liquid output reduce adjustment button 74. In this embodiment, by providing the display screen 71, it is convenient to display the mode of the multifunctional wine dispenser, remaining power of the rechargeable battery, a preset value of the single liquid output, and the pressure inside the bottle during vacuuming. Besides that, there is a start button 75 on the main control panel 7. The user can either turn the movable cover plate 61 to the second position to activate the multifunctional wine dispenser, or press the start button 75 to activate the multifunctional wine dispenser.

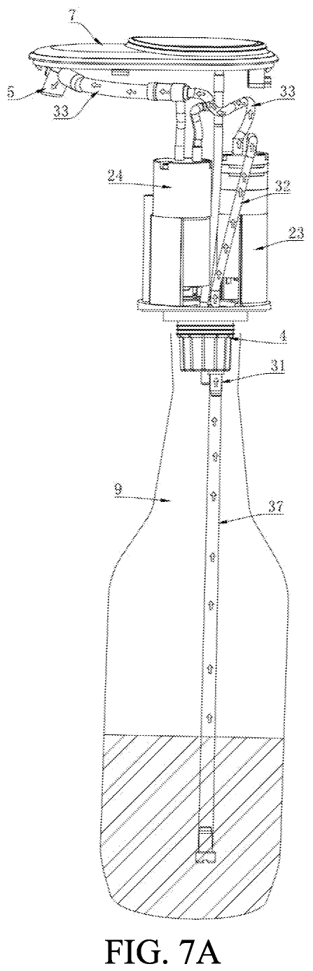

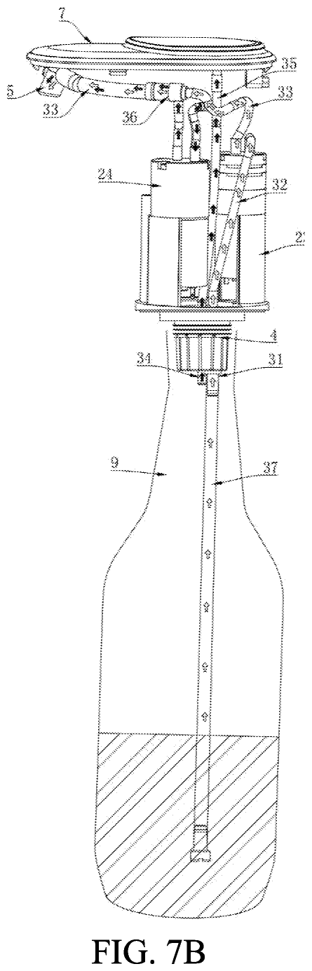

As shown in FIGS. 7-8, a usage method of the multifunctional wine dispenser described in any of the above embodiments, which needs to perform separate wine dispensing mode, wine decanting mode, cleaning mode, or vacuum pumping mode, is as follows.

As shown in FIGS. 7A, 7B, 8A and 8B, when the multifunctional wine dispenser needs to execute the separate wine dispensing mode, the usage method includes the following steps:
S11: ensuring that the plug-in bottle stopper 4 is separated from the vacuum sealing component 8, and connecting the extraction tube 37 to the liquid connection pipe 31;
S12: inserting the bottle stopper 4 directly into the bottle mouth of the wine bottle, and inserting the extraction tube 37 into the liquid of the wine bottle, there is a gap between the plug-in bottle stopper 4 and the bottle mouth, and at this time, the gas connection pipe 34 being connected to atmosphere;
S13: rotating the movable cover plate 61 to cause the second induction magnet 65 to a trigger position, enabling the multifunctional wine dispenser to be powered on and standby; selecting a mode of the multifunctional wine dispenser to enter the separate wine dispensing mode;
S14: determining whether the multifunctional wine dispenser adopts a quantitative liquid discharge method or an indefinite liquid discharge method; if the quantitative liquid output method is used, a single liquid output of the multifunctional wine dispenser can be set by adjusting the liquid output increase adjustment button 73 and the liquid output reduce adjustment button 74; if the single liquid output is set to 0 mL, it means that an indefinite liquid output method is used;
S15: rotating the movable cover plate 61 to the second position or pressing the start button 75 to activate the multifunctional wine dispenser; the water pump 23 starting to extract the liquid from the wine bottle and transferring it to the liquid outlet nozzle 5 through the liquid outlet pipe 33 for discharge;
S16: if the multifunctional wine dispenser adopts a quantitative liquid output method, when the liquid output reaching a preset single liquid output, the water pump 23 stops working and completes a separate wine output process; if the multifunctional wine dispenser adopts the indefinite liquid discharge method, the user needs to rotate the movable cover plate 61 away from the second position or press the start button 75 again to stop the water pump 23 from working, completing a separate wine discharge process.

As shown in FIG. 7B, when the multifunctional wine dispenser needs to execute the wine decanting mode, the usage method includes the following steps:
S21: ensuring that the plug-in bottle stopper 4 is separated from the vacuum sealing component 8, and connecting the extraction tube 37 to the liquid connection pipe 31;
S22: inserting the plug-in bottle stopper 4 directly into the bottle mouth of the wine bottle, and inserting the extraction tube 37 into the liquid of the wine bottle, there is a gap between the bottle stopper 4 and the bottle mouth, and at this time, the gas connection pipe 34 being connected to the air;
S23: rotating the movable cover plate 61 to cause the second induction magnet 65 reach the trigger position, so that the multifunctional wine dispenser is powered on and standby, selecting the mode of the multifunctional wine dispenser to enter the wine decanting mode;
S24: determining whether the multifunctional wine dispenser adopts the quantitative liquid discharge method or the indefinite liquid discharge method; if the quantitative liquid output method is used, the single liquid output of the multifunctional wine dispenser can be set by adjusting the liquid output increase adjustment button 73 and the liquid output reduce adjustment button 74; if the single liquid output is set to 0 mL, it means that the indefinite liquid output method is used;
S25: rotating the movable cover plate 61 to the second position or pressing the start button 75 to start the multifunctional wine dispenser; the water pump 23 and the air pump 24 start working; the water pump 23 starting to extract liquid from the wine bottle and transferring it to the liquid outlet nozzle 5 through the liquid outlet pipe 33 for discharge; at the same time, the air pump 24 starting to extract gas from the atmosphere and injecting it into the liquid in the liquid outlet pipe 33 to decant the liquid in the liquid outlet pipe 33;
S26: if the multifunctional wine dispenser adopts the quantitative liquid output method, when the liquid output reaching the preset single liquid output, the water pump 23 and the air pump 24 stop working, completing one wine decanting mode process; if the multifunctional wine dispenser adopts the indefinite liquid discharge method, the user needs to rotate the movable cover plate 61 away from the second position or press the start button 75 again to stop the water pump 23 and the air pump 24 from working, completing the wine decanting mode process.

When the multifunctional wine dispenser needs to execute the cleaning mode, the usage method includes the following steps:
S31: ensuring that the plug-in bottle stopper 4 is separated from the vacuum sealing component 8, and connecting the extraction tube 37 to the liquid connection pipe 31;
S32: preparing a container containing clean water, directly insert the plug-in bottle stopper 4 into a container mouth, and inserting the extraction tube 37 into the clean water, there is a gap between the plug-in bottle stopper 4 and the container mouth, and at this time, the gas connection pipe 34 being connected to the atmosphere;
S33: rotating the movable cover plate 61 to cause the second induction magnet 65 to the trigger position, enabling the multifunctional wine dispenser to be powered on and standby; selecting the mode of the multifunctional wine dispenser to enter the cleaning mode;
S34: rotating the movable cover plate 61 to the second position or pressing the start button 75 to start the multifunctional wine dispenser; the water pump 23 starting to extract clean water from the container and transferring it to the liquid outlet nozzle 5 through the liquid outlet pipe 33 for discharge; when a working time of the water pump 23 reaches 40-70 seconds, it stops working; then the air pump 24 starting to extract gas from the atmosphere and injecting it into the liquid outlet pipe 33, when a working time of the air pump 24 reaches 5-20 seconds, it stops working; completing one cleaning process; during the cleaning process, the user can stop the cleaning process at any time by rotating the movable cover plate 61 away from the second position or pressing the start button 75 again.

As shown in FIG. 8A, when the multifunctional wine dispenser needs to execute the vacuum mode, the usage method includes the following steps:
S41: ensuring that there is no extraction tube 37 connected to the liquid connection pipe 31, and that the vacuum sealing component 8 is connected to the plug-in bottle stopper 4; the gas connection pipe 34 driving the elastic sealing plug 81 to open the vacuum sealing component 8;
S42: inserting the vacuum sealing component 8 into the bottle mouth of the wine bottle, there is no gap between the vacuum sealing component 8 and the bottle mouth; at this time, the gas connection pipe 34 being connected to the air inside the bottle through the vacuum sealing component 8, and the gas connection pipe 34 being respectively connected to the air inlet end of the air pump 24 and the air pressure detector 25 through the first three-way pipe 35;
S43: rotating the movable cover plate 61 to cause the second induction magnet 65 to the trigger position, enabling the multifunctional wine dispenser to be powered on and standby; selecting the mode of the multifunctional wine dispenser to enter the vacuum mode;
S44: rotating the movable cover plate 61 to the second position or press the start button 75 to activate the multifunctional wine dispenser; the air pump 24 starting to extract gas from the wine bottle and transferring it to the liquid outlet pipe 33; the gas being then transferred to the liquid outlet nozzle 5 through the liquid outlet pipe 33 for discharge; at the same time, the air pressure detector 25 detecting the pressure inside the wine bottle;
S46: when the air pressure inside the wine bottle reaching a required level, the air pump 24 stops working and completes a vacuuming process; during the vacuuming process, the user can stop the vacuuming process at any time by rotating the movable cover plate 61 away from the second position or pressing the start button 75 again.

After vacuuming is completed, the user separates the bottle stopper 4 from the vacuum sealing component 8, and the elastic sealing plug 81 closes the vacuum sealing component 8. The vacuum sealing component 8 remains at the bottle mouth of the wine bottle and seals the bottle mouth.

The above embodiments only express some embodiments of the present disclosure, and their descriptions are more specific and detailed, but should not be understood as limiting the scope of the present disclosure. It should be noted that for those skilled in the art, many modifications and improvements can be made without departing from the concept of the present disclosure, which are within the protection scope of the present disclosure. Therefore, the protection scope of the present disclosure should be based on the attached claims.

What is claimed is:

1. A vacuum sealing component, wherein the vacuum sealing component comprises a sealing plug and an upper cover provided at an upper end of the sealing plug; the upper cover and the sealing plug are provided with an installation cavity, the upper cover is provided with a first through hole communicated to the installation cavity;
the sealing plug is provided with a second through hole communicated to the installation cavity, and an elastic sealing plug configured to control opening or closing of the first through hole is provided in the installation cavity; a top of the upper cover is provided with an insertion slot, and an upper end of the elastic sealing plug is configured to pass through the first through hole and extend into the insertion slot.

2. The vacuum sealing component according to claim 1, wherein the sealing plug comprises an installation bracket and a cock body sleeved outside the installation bracket, and the installation cavity is provided in the installation bracket.

3. The vacuum sealing component according to claim 1, wherein a sealing gasket is provided at one end of the installation cavity close to the first through hole.

4. The vacuum sealing component according to claim 3, wherein the sealing gasket extends into the first through hole, and a third through hole connected to the installation cavity is provided in a portion of the sealing gasket that is located in the first through hole, and the elastic sealing plug is configured to control opening or closing of the third through hole.

5. The vacuum sealing component according to claim 1, wherein the elastic sealing plug comprises a sealing plug and an elastic member arranged between the sealing plug and a bottom of the installation cavity.

6. The vacuum sealing component according to claim 5, wherein the sealing plug comprises a plug body and a conical plug arranged at an upper end of the plug body.

7. The vacuum sealing component according to claim 6, wherein the sealing plug further comprises a lower needle shaped rod and an upper needle shaped rod,
wherein the lower needle shaped rod is arranged at a lower end of the plug body, and the upper needle shaped rod is arranged at an upper end of the conical plug.

8. The vacuum sealing component according to claim 7, wherein the elastic member is a compression spring, and the elastic member is sleeved on an outer circumferential side of the lower needle shaped rod.

9. The vacuum sealing component according to claim 1, wherein the vacuum sealing component further comprises a rotating ring, wherein the sealing plug and the upper cover are both provided in the rotating ring,
the rotating ring is configured to rotate relative to the upper cover.

10. The vacuum sealing component according to claim 9, wherein the rotating ring is provided with a plurality of markings and Arabic numerals along a circumferential direction, and the upper cover is provided with an indicator triangle configured to point to the markings or Arabic numerals.
